(19) United States
(12) Patent Application Publication
(10) Pub. No.: US 2010/0138670 A1
(43) Pub. Date: Jun. 3, 2010

(54) STORAGE APPARATUS AND DATA WRITING METHOD

(75) Inventors: Takahiro Shinbori, Kawasaki (JP); Yoshiyuki Kudo, Kawasaki (JP); Hideaki Tanaka, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/568,330

(22) Filed: Sep. 28, 2009

(30) Foreign Application Priority Data
Nov. 28, 2008 (JP) 2008-303316

(51) Int. Cl. G06F 12/14; H04L 9/00

(52) U.S. Cl. 713/189; 380/277

(57) ABSTRACT

According to one embodiment, a storage apparatus includes: a controller encrypting user data with a key, and writing the encrypted user data in a storage medium; and a key changing module changing the key. The storage medium includes a user data region and a key changing region. When the key is changed, the controller divides the user data written in the storage medium into a plurality of pieces, encrypts a piece of the user data adjacent to the key changing region with the changed key, writes the encrypted piece into the key changing region, sequentially shifts each of the pieces other than the piece of the user data adjacent to the key changing region by one logical block size in a direction toward the key changing region, and writes the shifted pieces.

### CROSS-REFERENCE TO RELATED APPLICATIONS

This application is based upon and claims the benefit of priority from Japanese Patent Application No. 2008-303316, filed Nov. 28, 2008, the entire contents of which are incorporated herein by reference.

### BACKGROUND

1. Field

One embodiment of the invention relates to a storage apparatus and a data writing method, and particularly to a storage apparatus and a data writing method that encrypt, when a key for encrypting user data in a storage medium is changed, the user data with a new key and safely write the encrypted data into the storage medium.

2. Description of the Related Art

In recent years, from the point of view of protecting confidential information and avoiding information leakage, demands for magnetic storage apparatuses and optical storage apparatuses having security functions are increasing. Examples of such storage apparatuses having security functions are a magnetic storage apparatus that reads out, when a key used to encrypt the user data (decryption or encryption) is changed, a part of the user data stored in a sector on a storage medium, encrypts the read user data with the changed key, and write the encrypted user data into the same sector, or a magnetic storage apparatus that retreats the encrypted user data into a temporal retreat region, and writes the retreated user data into the same sector.

There is also proposed a data processing apparatus that encrypts data to be written into a storage medium with random numbers generated by an M-series random number generation module serving as a encryption key (see Japanese Patent Application Publication (KOKAI) No. 2006-259988).

Conventional magnetic storage apparatuses that read out user data, encrypt the read user data with a new key, and write back the encrypted user data into the same sector, when a key is changed, may lose the user data when the power is turned off while writing the encrypted user data into the same sector. Further, a conventional magnetic storage apparatuses that write the encrypted user data into the same sector after the encrypted user data is retreated to a temporal retreat region requires much time for writing the user data when a key is changed.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of a storage apparatus according to one embodiment of the invention;

FIG. 2 is an exemplary explanatory diagram of an encryption-key-changing region in the embodiment;

FIG. 3 is an exemplary explanatory diagram of an encryption key changing process according to a first embodiment of the invention;

FIG. 4 is an exemplary explanatory diagram of the encryption key changing process in the first embodiment;

FIG. 5 is an exemplary flowchart of the encryption key changing process in the first embodiment;

FIG. 6 is an exemplary explanatory diagram of an encryption key changing process according to a second embodiment of the invention;

FIG. 7 is an exemplary flowchart of the encryption key changing process in the second embodiment;

FIG. 8 is an exemplary explanatory diagram of an encryption key changing process according to a third embodiment of the invention; and

FIG. 9 is an exemplary flowchart of the encryption key changing process in the third embodiment.

### DETAILED DESCRIPTION

Various embodiments according to the invention will be described hereinafter with reference to the accompanying drawings. In general, according to one embodiment of the invention, a storage apparatus includes: a controller configured to encrypt user data with a key, and write the encrypted user data in a storage medium; and a key changing module configured to change the key. The storage medium includes a user data region storing the encrypted user data and a key changing region of a logical block with a predetermined size, the key changing region being adjacent to the user data region. When the key is changed, the controller is configured to divide the user data written in the storage medium into a plurality of pieces of the user data each corresponding to a logical block size of the logical block, encrypt a piece of the user data adjacent to the key changing region with the changed key, write the encrypted piece into the key changing region, sequentially shift each of the pieces of the user data other than the piece of the user data adjacent to the key changing region by one logical block size in a direction toward the key changing region from positions in the storage region in which the pieces of the divided user data other than the piece of the divided user data adjacent to the key changing region are written, and write the shifted pieces.

According to another embodiment of the invention, a data writing method applied to a storage apparatus including a controller and a key changing module, the controller being configured to encrypt user data with a key, and write the encrypted user data in a storage medium, the key changing module being configured to change the key, the storage medium including a user data region storing the encrypted user data and a key changing region of a logical block with a predetermined size, the key changing region being adjacent to the user data region, the data writing method includes: when the key is changed, the controller of the storage apparatus dividing the user data written in the storage medium into a plurality of pieces of the user data each corresponding to a logical block size of the logical block, encrypting a piece of the user data adjacent to the key changing region with the changed key, writing the encrypted piece into the key changing region, sequentially shifting each of the pieces of the user data other than the piece of the user data adjacent to the key changing region by one logical block size in a direction toward the key changing region from positions in the storage region in which the pieces of the divided user data other than the piece of the divided user data adjacent to the key changing region are written, and writing the shifted pieces.

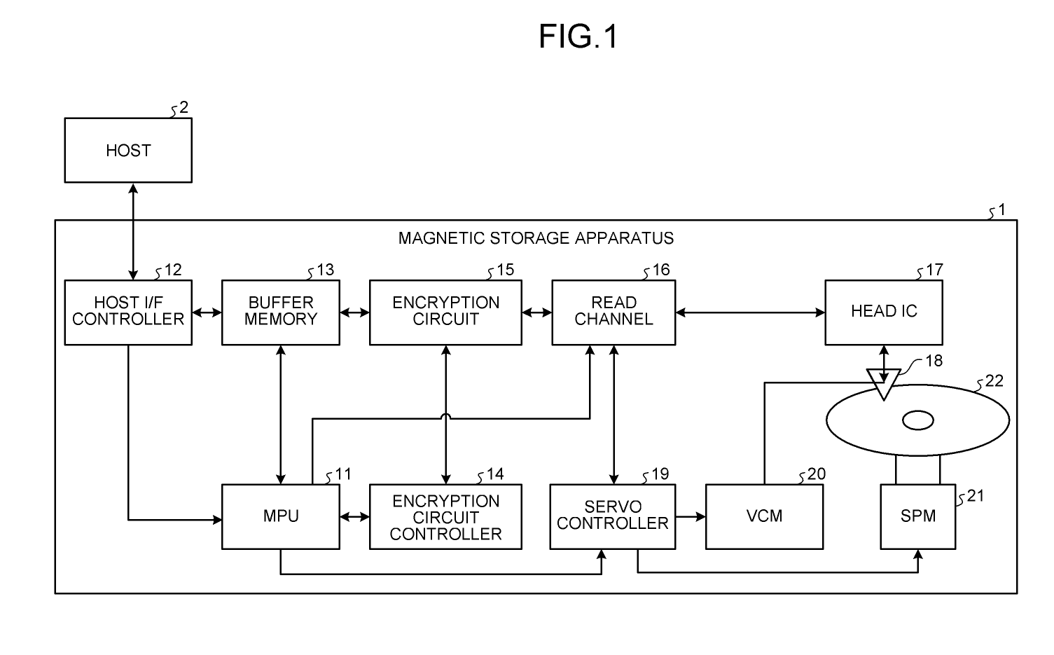

FIG. 1 is a block diagram of a storage apparatus according to one embodiment. The storage apparatus according to the embodiment is a magnetic storage apparatus 1 such as a hard disk drive (HDD). The magnetic storage apparatus 1 includes a micro processing unit (MPU) 11, a host interface (I/F) controller 12, a buffer memory 13, an encryption circuit controller 14, an encryption circuit 15, a read channel 16, a head integrated circuit (IC) 17, a head 18, a servo controller 19, a voice coil motor (VCM) 20, and a spindle motor (SPM) 21.

The MPU 11 controls the entire magnetic storage apparatus 1. The host I/F controller 12 is an interface between a host computer (host) 2 and the magnetic storage apparatus 1, and receives a request (a read request, a write request, or a key change request) from the host 2 to inform the MPU 11 of the request. The host I/F controller 12 also returns a response for the request to the host 2 according to an instruction of the MPU 11. The host 2 requests key change by sending a key change command for changing a key used to encrypt the user data, to the magnetic storage apparatus 1 via the host I/F controller 12.

The buffer memory 13 stores therein user data read out from a storage medium 22 and user data to which a write request from the host 2 is subjected. The encryption circuit controller 14 controls the encryption circuit 15 according to an instruction of the MPU 11 to change a key to be used by the encryption circuit 15. More specifically, once the MPU 11 receives a key change request from the host 2, the MPU 11 instructs the encryption circuit controller 14 to change the key to be used by the encryption circuit 15 for encrypting the user data.

The encryption circuit 15 uses the key to encrypt the user data (encryption or decryption) stored in the buffer memory 13. The read channel 16 reads out the user data in the storage medium 22 through the head IC 17 and the head 18 according to an instruction of the MPU 11. The read channel 16 also writes user data encrypted by the encryption circuit 15 into the storage medium 22 through the head IC 17 and the head 18 according to an instruction of the MPU 11. The head IC 17, as is well known, reads out user data from the storage medium 22, and writes the user data into the storage medium 22 through the head 18. The servo controller 19 controls and enables the VCM 20 to perform positioning control of the head 18 according to an instruction of the MPU 11. The servo controller 19 also controls the SPM 21. The VCM 20 performs the positioning control of the head 18 according to an instruction of the servo controller 19. The SPM 21, as is well known, rotationally drives the storage medium 22 according to an instruction of the servo controller 19. User data is written into the storage medium 22.

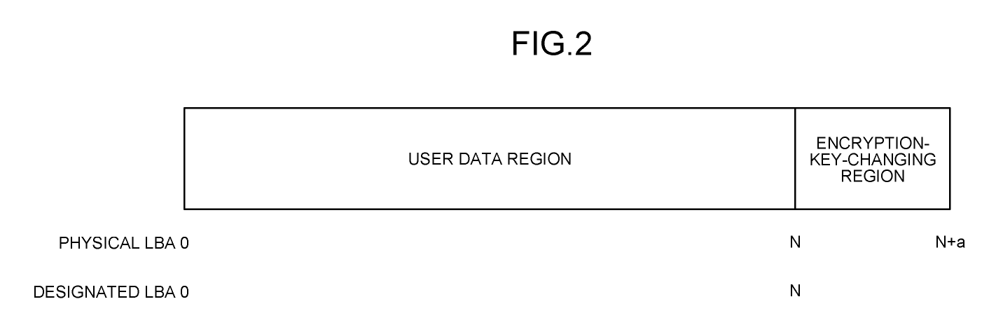

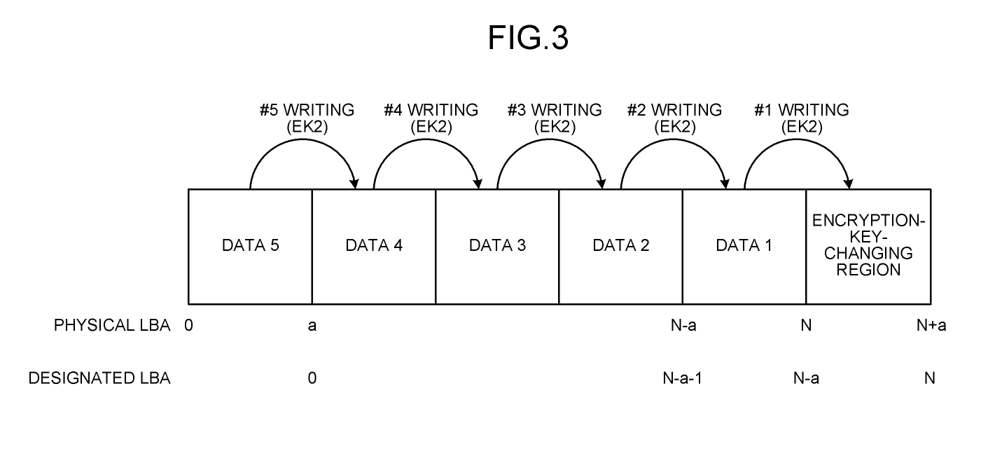

FIG. 2 is a diagram illustrating an encryption-key-changing region. In the embodiment, as illustrated in FIG. 2, the storage region of the storage medium includes a user data region storing the user data and an encryption-key-changing region, which is a region used for changing the key. Divided user data is written into the encryption-key-changing region when performing a key changing process. The encryption-key-changing region is provided adjacent to the user data region. Note that “Physical LBA” illustrated in FIG. 2 is a logical block address (LBA) managed by the magnetic storage apparatus, and a designated LBA is an LBA designated by the host (the same can be said for FIGS. 3, 4, and 6).

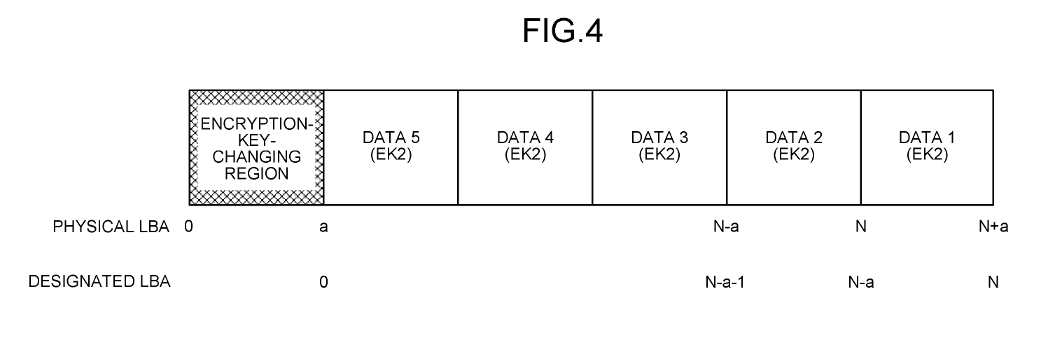

FIGS. 3 and 4 are diagrams for explaining an encryption key changing process of a first embodiment. It is assumed herein that the user data is encrypted with a key EK1 before changing the encryption key. Once receiving a key change command from the host 2, the MPU 11 instructs the encryption circuit controller 14 to change the key to be used by the encryption circuit 15 for encrypting the user data, from EK1 to EK2. As illustrated in FIG. 3, the MPU 11 divides the user data corresponding to the key to be changed into a plurality (five in FIG. 3) of pieces of user data each with a predetermined logical block size corresponding to the encryption-key-changing region, reads out the pieces of the user data, and sequentially stores the pieces of the user data in the buffer memory 13. The MPU 11 controls the encryption circuit 15 to encrypt a piece of the user data (data 1) adjacent to the encryption-key-changing region among the divided user data in the buffer memory 13 with the key EK2, and writes the encrypted piece into the encryption-key-changing region (see #1 in FIG. 3). The MPU 11 then sequentially shifts each piece of the user data (data 2 to 5) other than the data 1 in a direction toward the encryption-key-changing region (see #2 to #5 in FIG. 3), and writes the shifted data. The MPU 11 sets the storage region in which the shifted piece was written as a new encryption-key-changing region, for example, every time the piece is shifted.

After the key changing process, the user data that is encrypted with the encryption key EK2 as illustrated in FIG. 4 is written in the storage medium. When changing the encryption key EK2, the MPU 11 uses the shading portion adjacent to the user data in FIG. 4 as a new encryption-key-changing region to perform the key changing process same as the key changing process explained with reference to FIG. 3.

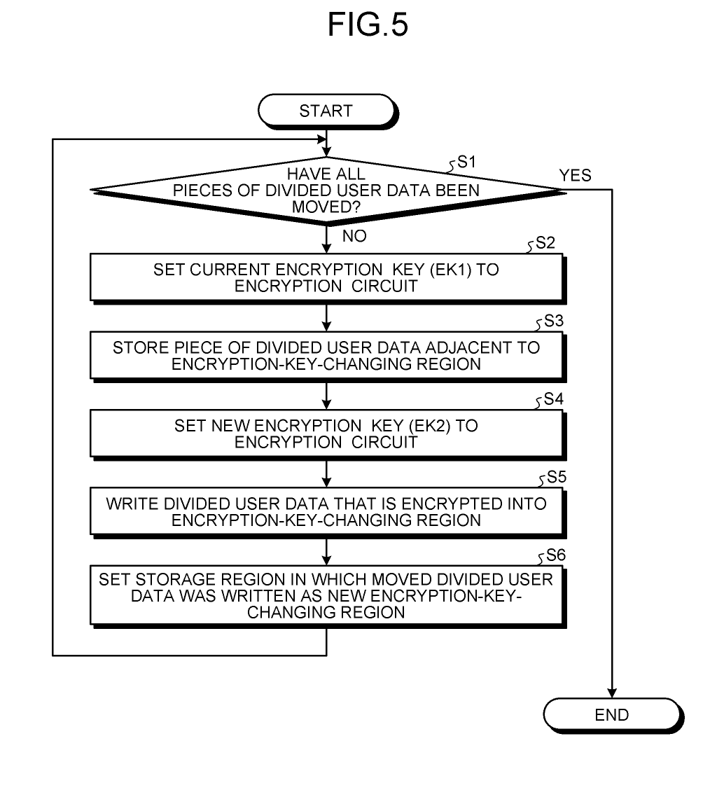

FIG. 5 is an exemplary flowchart of the encryption key changing process of the first embodiment. First, the MPU 11 determines whether all pieces of the divided user data have been shifted (S1). If the MPU 11 determines that the all pieces have been shifted, the process is terminated. If the MPU 11 determines that a piece of the divided user data remains not shifted, the MPU 11 controls the encryption circuit controller 14 to set the current encryption key (EK1) to the encryption circuit 15 (S2). The encryption circuit 15 decrypts the piece of the divided user data to be shifted with the set key EK1. The MPU 11 then stores the piece of the divided user data adjacent to the encryption-key-changing region in the buffer memory 13 (S3). The MPU 11 controls the encryption circuit controller 14 to set a new encryption key (EK2) to the encryption circuit 15 (S4). The encryption circuit 15 uses the set key EK2 to encrypt the piece of the divided user data to be shifted and being stored in the buffer memory 13. The MPU 11 then writes the encrypted piece of the divided user data into the encryption-key-changing region (S5). By S5, the divided user data is shifted into the encryption-key-changing region. After S5, the MPU 11 sets the storage region where the shifted piece of divided user data was written as a new encryption-key-changing region (S6), and the process returns to S1.

According to the first embodiment, even when the power is shut down while the data encrypted with the new key is being written into the encryption-key-changing region, the original data is stored still in the region where the shifted data was stored, thereby preventing data loss. As a result, it is possible to safely write the data encrypted with the new key into the storage medium.

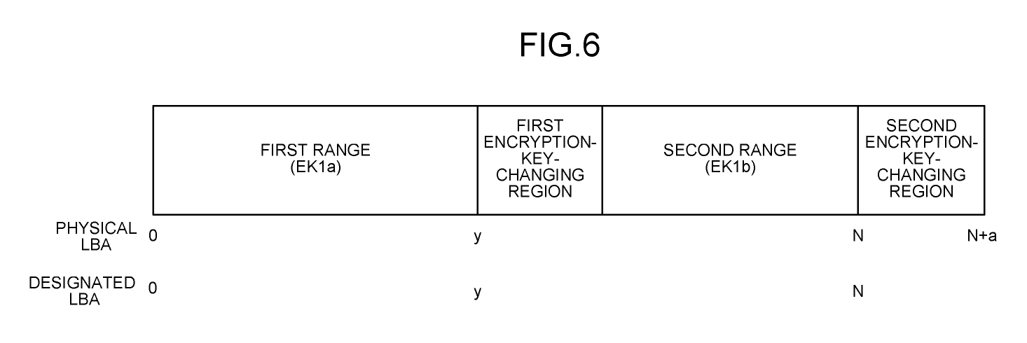

FIG. 6 is a diagram for explaining an encryption key changing process of a second embodiment. In the second embodiment, the user data region of the storage medium 22 is divided into a first range and a second range, corresponding to a plurality of ranges each using different key for encrypting the user data. For example, a key corresponding to the first range is EK1a and a key corresponding to the second range is EK1b. The encryption-key-changing region of a logical block with a predetermined size is provided so as to be adjacent to and so as to correspond to each range. In the example illustrated in FIG. 6, a first encryption-key-changing region corresponding to the first range and a second encryption-key-changing region corresponding to the second range are provided. If a key change command received by the MPU 11 from the host 2 relates to the first range of user data region, the MPU 11 performs the encryption key changing process in a similar manner as to that of the first embodiment explained with reference to FIGS. 3 and 4 on the user data of the first range. That is, the MPU 11 divides the user data of the first range corresponding to the key to be changed as the divided user data, encrypts a piece of the divided user data adjacent to the first encryption-key-changing region with a new key, and then writes the encrypted piece of the divided user data into the first encryption-key-changing region. Moreover, the MPU 11 sequentially shifts each piece of the divided user data in the first range other than the one that has been written into the first encryption-key-changing region in a direction toward the first encryption-key-changing region, and writes the each piece of the divided user data in the first range other than the one that has been written into the first region. If a key change command received by the MPU 11 from the host 2 relates to the user data region of the second range, the MPU 11 performs the encryption key changing process on the user data in the second range in a similar manner to the process described above.

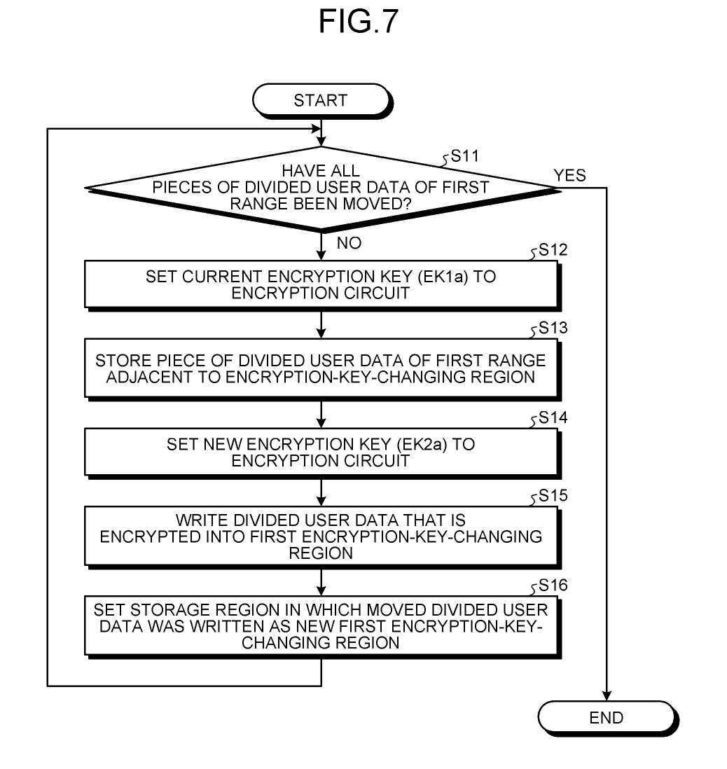

FIG. 7 is a flowchart of the encryption key changing process of the second embodiment. In the second embodiment, an encryption key changing process where a key change command received by the MPU 11 from the host 2 relates to the user data region of the first range will be explained.

First, the MPU 11 determines whether all pieces of the divided user data of the first range have been shifted (S11). If the MPU 11 determines all pieces of the divided user data of the first range have been shifted, the process is terminated. If the MPU 11 determines a piece of the divided user data of the first range remains not shifted, the MPU 11 controls the encryption circuit controller 14 to set the current encryption key (EK1a) to the encryption circuit 15 (S12). The MPU 11 then stores the piece of the divided user data of the first range adjacent to the first encryption-key-changing region in the buffer memory 13 (S13). The MPU 11 controls the encryption circuit controller 14 to set a new encryption key (EK2a) to the encryption circuit 15 (S14). By S14, the piece of the divided user data stored in the buffer memory 13 is encrypted with the key EK2a. The MPU 11 writes the encrypted piece of the divided user data into the first encryption-key-changing region (S15). By S15, the divided user data is shifted into the encryption-key-changing region. After S15, the MPU 11 sets the storage region in which the shifted divided user data was written as a new first encryption-key-changing region (S16), and the process returns to S11.

According to the second embodiment, it is possible to sequentially write pieces of the divided user data to be shifted into a region for changing a key corresponding to the range of the divided user data.

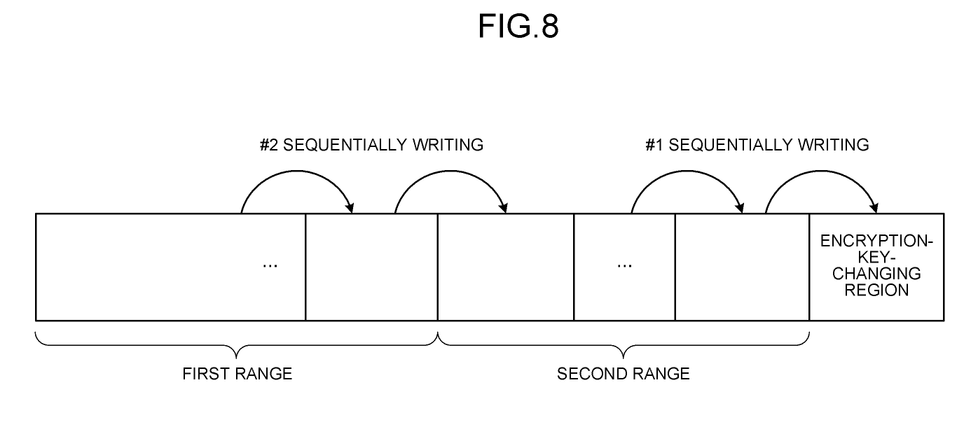

FIG. 8 is an explanatory diagram of an encryption key changing process of a third embodiment. In the third embodiment, similarly to the second embodiment, the user data region of the storage medium 22 is divided into the first range with the corresponding key EK1a and the second range with the corresponding key EK1b. Moreover, an encryption-key-changing region with a logical block of a predetermined size is provided adjacent to any one of the ranges. In the third embodiment, not only the user data with a corresponding key is changed but also the user data with an unchanged key is to be shifted in a direction toward the encryption-key-changing region.

As illustrated in FIG. 8, it is assumed herein that the encryption-key-changing region is provided adjacent to the second range. When a key change command received by the MPU 11 from the host 2 relates to the user data region of the first range, the MPU 11 divides the user data of the second range into a plurality of pieces of second divided user data and the user data of the first range into a plurality of pieces of first divided user data. The MPU 11 sequentially stores the pieces of the second divided user data in the buffer memory 13 without decryption. Alternatively, the MPU 11 may sequentially store the pieces of the second divided user data in the buffer memory 13 after decryption with any key (for example, with the key EK1b used to encrypt the second divided user data). Then, the MPU 11 decrypts the pieces of the first divided user data with the key EK1a used to encrypt thereof, and sequentially stores the pieces of the first divided user data in the buffer memory 13.

Subsequently, the MPU 11 sequentially shifts each piece of the second divided user data in a direction toward the encryption-key-changing region (see #1 in FIG. 8), and writes the each shifted piece. The MPU 11 sets the storage region in which the shifted second divided user data was written as a new encryption-key-changing region, for example, every time the second divided user data is shifted (the same applies to the shifting of the first divided user data described later). That is, in the third embodiment, the pieces of the divided user data adjacent to the sequentially set encryption-key-changing region are to be shifted. Once all pieces of the second divided user data have been shifted, the MPU 11 encrypts the first divided user data stored in the buffer memory 13 with the new key EK2a. The MPU 11 then sequentially shifts the encrypted pieces of the first divided user data in a direction toward the encryption-key-changing region (see #2 in FIG. 8), and writes the shifted pieces.

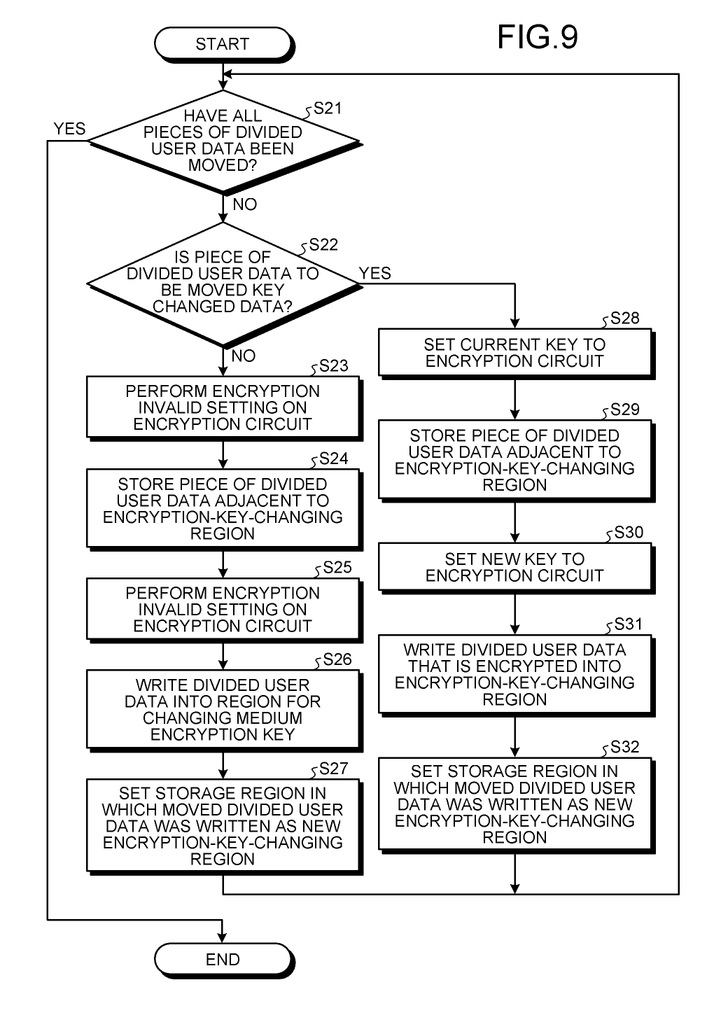

FIG. 9 is a flowchart of the encryption key changing process of the third embodiment. The MPU 11 determines whether all pieces of the divided user data have been shifted (S21). If the MPU 11 determines all pieces of the divided user data have been shifted, the process is terminated. If the MPU 11 determines a piece of the divided user data remains not shifted, the MPU 11 determines whether the piece of the divided user data to be shifted is the divided user data in the range corresponding to the key to be changed (key changed data) (S22). If the MPU 11 determines the piece of the divided user data to be shifted is not the key changed data, the MPU 11 controls the encryption circuit controller 14 to perform a encryption invalid setting on the encryption circuit 15 (S23). The encryption invalid setting is a setting not to perform the encryption processing on the divided user data.

Then, the MPU 11 stores the piece of the divided user data adjacent to the encryption-key-changing region in the buffer memory 13 (S24). The MPU 11 controls the encryption circuit controller 14 to perform the encryption invalid setting on the encryption circuit 15 (S25). The MPU 11 then writes the divided user data stored in the buffer memory 13 into the encryption-key-changing region (S26). By S26, the divided user data is shifted into the encryption-key-changing region. After S26, the MPU 11 sets the storage region in which the shifted divided user data was written as a new encryption-key-changing region (S27), and the process returns to S21.

At S22, if the MPU 11 determines the piece of the divided user data to be shifted is the key changed data, the MPU 11 controls the encryption circuit controller 14 to set the current key (the key originally used for the encryption processing of the key changed data) to the encryption circuit 15 (S28). The encryption circuit 15 uses the set current key to decrypt the piece of the divided user data to be shifted and being stored in the buffer memory 13. The MPU 11 then stores the piece of the divided user data to be shifted, that is, a piece of the divided user data adjacent to the encryption-key-changing region, in the buffer memory 13 (S29). The MPU 11 controls the encryption circuit controller 14 to set a new key to the encryption circuit 15 (S30). The encryption circuit 15 uses the set new key to encrypt the piece of the divided user data to be shifted and stored in the buffer memory 13.

Subsequently, the MPU 11 writes the divided user data that is encrypted with the new key into the encryption-key-changing region (S31). By S31, the divided user data is shifted into the encryption-key-changing region. After S31, the MPU 11 sets the storage region in which the shifted divided user data was written as a new encryption-key-changing region (S32), and the process returns to S21.

Instead of S23, the MPU 11 may set any key to decrypt a piece of the divided user data to be shifted with the set key. Moreover, instead of S25, the MPU 11 may set any key as mentioned above to encrypt a piece of the divided user data to be shifted with the set key.

According to the third embodiment, it is possible to encrypt the divided user data in a range corresponding to a new key with the new key, sequentially shift pieces of the divided user data in a direction toward the encryption-key-changing region, and write the shifted pieces. Further, according to the third embodiment, it is possible to sequentially shift pieces of the divided user data in a range other than the range corresponding to the new key in a direction toward the encryption-key-changing region, and write the shifted pieces, without the encryption processing.

In the storage apparatus and the data writing method, when a key is changed, the user data written in the storage medium is divided into a plurality of pieces of user data. A piece of the divided user data adjacent to the key-changing region, which is provided on the storage medium, is encrypted with the new key and written into the key-changing region. In addition, pieces of the divided user data other than the one adjacent to the key-changing region are sequentially shifted in a direction from positions in the storage region where the pieces of the divided user data are written toward the key-changing region, and written. Consequently, with the storage apparatus and the data writing method of one of the embodiments, even if power is turned off while the data encrypted with the new key is being written into the key-changing region, the original data remains in the region before it is shifted, thereby preventing data loss. As a result, it is possible to safely write the data encrypted with the new key into the storage medium.

Furthermore, in the storage apparatus and the data writing method, unlike conventional storage apparatuses, user data encrypted with a new key is not written in the same sector after it is retreated to a temporal retreat region. Consequently, it is possible to rapidly write the user data encrypted with the new key into the storage medium.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A storage apparatus comprising:
a controller configured to encrypt user data with a key, and write the encrypted user data in a storage medium; and
a key changing module configured to change the key, wherein the storage medium includes a user data region storing the encrypted user data and a key changing region of a logical block with a predetermined size, the key changing region being adjacent to the user data region, and
when the key is changed, the controller is configured to divide the user data written in the storage medium into a plurality of pieces of the user data each corresponding to a logical block size of the logical block, encrypt a piece of the user data adjacent to the key changing region with the changed key, write the encrypted piece into the key changing region, sequentially shift each of the pieces of the user data other than the piece of the user data adjacent to the key changing region by one logical block size in a direction toward the key changing region from positions in the storage region in which the pieces of the divided user data other than the piece of the divided user data adjacent to the key changing region are written, and write the shifted pieces.

2. The storage apparatus of claim 1, wherein the user data region of the storage medium is divided into a plurality of ranges each corresponding to different keys used to encrypt the user data, and the key changing region is provided to be adjacent to and to correspond to each of the ranges.

3. The storage apparatus of claim 1, wherein
the user data region of the storage medium is divided into a plurality of ranges each corresponding to different key used to encrypt the user data, and
when the key corresponding to one of the ranges is changed, the controller is configured to divide the user data written in the storage medium into a plurality of pieces of the user data each corresponding to the logical block size, encrypt the pieces of the user data in the range corresponding to the changed key, sequentially shift the encrypted pieces by one logical block size in a direction toward the key changing region, write the shifted and encrypted pieces, sequentially shift the pieces of the user data in the range other than the range corresponding to the changed key by one logical block size in the direction toward the key changing region, and write the shifted pieces.

4. The storage apparatus of claim 1, wherein
the user data region of the storage medium is divided into a plurality of ranges each corresponding to different key used to encrypt the user data, and
when the key corresponding to one of the ranges is changed, the controller is configured to divide the user data written in the storage medium into a plurality of pieces of the user data each corresponding to the logical block size, encrypt the pieces of the user data in the range corresponding to the changed key, sequentially shift the encrypted pieces by one logical block size in a direction toward the key changing region, write the shifted and encrypted pieces, encrypt the pieces of the user data in the range other than the range corresponding to the changed key with a key used to encrypt the pieces of the user data in the range other than the range corresponding to the changed key, sequentially shift the pieces of the user data in the range other than the range corresponding to the changed key by one logical block size in the direction toward the key changing region, and write the shifted pieces.

5. A data writing method applied to a storage apparatus including a controller and a key changing module, the controller being configured to encrypt user data with a key, and write the encrypted user data in a storage medium, the key changing module being configured to change the key, the storage medium including a user data region storing the encrypted user data and a key changing region of a logical block with a predetermined size, the key changing region being adjacent to the user data region, the data writing method comprising:
when the key is changed, the controller of the storage apparatus dividing the user data written in the storage medium into a plurality of pieces of the user data each corresponding to a logical block size of the logical block, encrypting a piece of the user data adjacent to the key changing region with the changed key, writing the encrypted piece into the key changing region, sequentially shifting each of the pieces of the user data other than the piece of the user data adjacent to the key changing region by one logical block size in a direction toward the key changing region from positions in the storage region in which the pieces of the divided user data other than the piece of the divided user data adjacent to the key changing region are written, and writing the shifted pieces.

6. The data writing method of claim 5, wherein the user data region of the storage medium is divided into a plurality of ranges each corresponding to different keys used to encrypt the user data, and the key changing region is provided to be adjacent to and to correspond to each of the ranges.

7. The data writing method of claim 5, wherein
the user data region of the storage medium is divided into a plurality of ranges each corresponding to different keys used to encrypt the user data, and
when the key corresponding to one of the ranges is changed, the controller of the storage apparatus divides the user data written in the storage medium into a plurality of pieces of the user data each corresponding to the logical block size, encrypts the pieces of the user data in the range corresponding to the changed key, sequentially shifts the encrypted pieces by one logical block size in a direction toward the key changing region, writes the shifted and encrypted pieces, sequentially shifts the pieces of the user data in the range other than the range corresponding to the changed key by one logical block size in the direction toward the key changing region, and writes the shifted pieces.

8. The data writing method of claim 5, wherein
the user data region of the storage medium is divided into a plurality of ranges each corresponding to different key used to encrypt the user data, and
when the key corresponding to one of the ranges is changed, the controller divides the user data written in the storage medium into a plurality of pieces of the user data each corresponding to the logical block size, encrypts the pieces of the user data in the range corresponding to the changed key, sequentially shifts the encrypted pieces by one logical block size in a direction toward the key changing region, writes the shifted and encrypted pieces, encrypts the pieces of the user data in the range other than the range corresponding to the changed key with a key used to encrypt the pieces of the user data in the range other than the range corresponding to the changed key, sequentially shifts the pieces of the user data in the range other than the range corresponding to the changed key by one logical block size in the direction toward the key changing region, and writes the shifted pieces.
